(19) United States
(12) Patent Application Publication
(10) Pub. No.: US 2006/0193545 A1
(43) Pub. Date: Aug. 31, 2006

(54) Rolling element bearing cage with improved pilot surface lubrication

(75) Inventors: Eric B. Bridges, Tempe, AZ (US); Arun Kumar, Chandler, AZ (US)

Correspondence Address: Honeywell International, Inc., Law Dept. AB2, P.O. Box 2245, Morristown, NJ, 07962-9806, US

(73) Assignee: Honeywell International Inc., Morristown, NJ (US)

(21) Appl. No.: 11/065,760

(22) Filed: Feb. 25, 2005

(51) Int. Cl. F16C 19/00

(52) U.S. Cl. 384/470

(57) ABSTRACT

The present invention provides a bearing cage comprising a centrifugal lubricant catcher and axial grooves for improved pilot surface lubrication. The centrifugal lubricant catcher may be a lip running circumferentially around one edge of the inner surface of the bearing cage and the axial grooves extend axially from the edge of the centrifugal lubricant catcher across the inner surface of the bearing cage. During operation, lubricant is captured by the lubricant catcher and centrifugally distributed to the piloting surfaces by the axial grooves. A method for using the bearing cage of the present invention is also provided.

### BACKGROUND OF THE INVENTION

The present invention relates generally to bearing assemblies and more specifically to bearing assemblies with rolling element bearing cages having axial grooves in the bore web surfaces and a centrifugal lubricant catcher.

High speed rolling element bearings require high strength separators (cages) to maintain relative position of the rolling elements during the bearing's high speed operation. These separators generally rotate at speeds that are roughly half of the average rotational speeds of the inner and outer rings. Thus, the separator rotational speeds are also high, and a separator piloting surface is required for smooth operation. The separator piloting surfaces can be either on the outer ring or the inner ring of the bearing, and are typically on either side of the rolling elements. In turbine engine rolling element bearings, there is a certain advantage to piloting the separator on the inner ring.

High speed rolling element bearings of the type utilized in gas turbine engines often exhibit wear between the rolling element separator pilot surfaces and the bearing inner ring lands. This wear is due to the difficulty in maintaining and replenishing the hydrodynamic lubrication film between these surfaces. The wear problem becomes more pronounced with increasing bearing speed, cage mass and pilot clearance. This wear can be severe enough to result in bearing failure in a matter of minutes. One way to resolve this wear problem is to introduce the lubricant between the shaft and the inner ring of the bearing, and use feed holes to centrifugally distribute the lubricant to the piloting surfaces. Such lubrication is called ‘under-race’ lubrication. However, in many designs ‘under-race’ lubrication cannot be incorporated. In such cases, an alternative solution is needed to improve the lubrication and eliminate wear of inner land piloted separators.

U.S. Pat. No. 3,597,031 discloses a ball bearing having a lubricant transfer recess or reservoir between the journal portions (or piloting surfaces) of the bearing cage. During operation of the ball bearing, a lubricant centrifugally collects in the reservoir and then passes to a bearing ball pocket through radial passages. The lubricant may also pass to the journal portions due to centrifugally developed pressure in the lubricating film. However, the transfer recesses are not designed to uniformly provide lubrication to the journal potions of the cage. Their primary purpose is to supply sufficient lubrication to the ball bearings during operation.

U.S. Pat. No. 5,106,209 discloses a bearing assembly including a split inner race having a plurality of center feed passages at the split line of the inner race along with at least one radial pilot passage in one of the inner race halves. The bearing assembly of the '209 patent lubricates bearing balls, raceways and bearing cage pilot surfaces with lubricant supplied at the inner diameter surface of the inner ring. There are no features, however, to bring lubricant in from an external jet and subsequently to enhance lubrication of the bearing cage pilot surfaces.

As can be seen, there is a need for a bearing assembly having enhanced lubrication of bearing cage pilot surfaces by bringing in lubricant from an external jet. It would also be desirable to have a bearing assembly that uniformly provides lubrication to bearing cage pilot surfaces.

### SUMMARY OF THE INVENTION

In one aspect of the invention there is provided a bearing cage for a rolling element bearing, the bearing cage comprising an inner surface; a plurality of cage pockets at predetermined intervals along the circumference of the bearing cage; a plurality of web bore surfaces on the inner surface, the plurality of web bore surfaces separating the plurality of cage pockets; a first centrifugal lubricant catcher running circumferentially around an edge of the inner surface of the bearing cage; and a plurality of axial grooves, the plurality of axial grooves extending axially along the plurality of web bore surfaces.

In another aspect of the invention there is provided a bearing cage for a rolling element bearing, the bearing cage comprising an inner surface; a plurality of cage pockets at predetermined intervals along the circumference of the bearing cage; a plurality of web bore surfaces on the inner surface, the plurality of web bore surfaces separating the plurality of cage pockets; a first centrifugal lubricant catcher running circumferentially around an edge of the inner surface of the bearing cage; a circumferential groove, the circumferential groove running circumferentially around the inner surface of the inner ring and adjacent to the centrifugal lubricant catcher; and a plurality of axial grooves, the plurality of axial grooves extending from the circumferential groove along the plurality of web bore surfaces.

In a further aspect of the present invention there is provided a bearing cage for a rolling element bearing, the bearing cage comprising an inner surface; a plurality of cage pockets at predetermined intervals along a circumference of the bearing cage; a plurality of web bore surfaces, the plurality of web bore surfaces separating the plurality of cage pockets; a first piloting surface and a second piloting surface, the first and second piloting surfaces being on the inner surface of the bearing cage and connected by the plurality of web bore surfaces; a centrifugal lubricant catcher, wherein the centrifugal lubricant catcher comprises a lip running circumferentially around an edge of the inner surface of the bearing cage adjacent to the first piloting surface; and a plurality of axial grooves extending axially from adjacent the centrifugal lubricant catcher along the first piloting surface and the plurality of web bore surfaces to the second piloting surface, wherein the axial grooves extend over from about 50% to about 75% of the second piloting surface.

In yet another aspect of the present invention there is provided a rolling element bearing assembly comprising an inner ring; an outer ring; a bearing cage concentrically disposed between the inner ring and the outer ring, the bearing cage comprising an inner surface, a plurality of cage pockets at predetermined intervals along a circumference of the bearing cage, a plurality of web bore surfaces, the web bore surfaces separating the plurality of cage pockets, a centrifugal lubricant catcher, wherein the centrifugal lubricant catcher comprises a lip running circumferentially around an edge of the inner surface of the bearing cage, and a plurality of axial grooves extending from adjacent the lip of the centrifugal lubricant catcher along the plurality of web bore surfaces; and a plurality of rolling elements, the rolling elements being disposed within the plurality of cage pockets.

In a further aspect of the present invention there is provided a bearing sump of a turbine engine comprising a shaft; a coupling shaft connected to the shaft; a bearing assembly comprising an inner ring, the inner ring connected to the coupling shaft, an outer ring, and a bearing cage concentrically disposed between the inner ring and the outer ring, the bearing cage comprising an inner surface, a plurality of cage pockets at predetermined intervals along a circumference of the bearing cage, a plurality of web bore surfaces, the plurality of web bore surfaces separating the plurality of cage pockets, a centrifugal lubricant catcher, wherein the centrifugal lubricant catcher comprises a lip running circumferentially around an edge of the inner surface of the bearing cage, and a plurality of axial grooves extending from adjacent the lip of the centrifugal lubricant catcher along the plurality of web bore surfaces; a bearing support housing, the bearing support housing connected to the outer ring of the bearing assembly; and a lubricant jet, the lubricant jet being positioned in the bearing support housing such that lubricant is delivered by the lubricant jet directly to the bearing assembly in such a way that the lubricant is captured by the centrifugal lubricant catcher.

In another aspect of the invention there is provided a method of lubricating a first piloting surface and a second piloting surface of a bearing cage of a bearing assembly comprising the steps of spraying a lubricant towards one side of the bearing cage; capturing the lubricant in a centrifugal lubricant catcher wherein the centrifugal lubricant catcher is on the side of the bearing cage sprayed with lubricant; centrifugally distributing the lubricant to a first piloting surface, wherein the first piloting surface is adjacent to the centrifugal lubricant catcher; capturing additional lubricant from the centrifugal lubricant catcher in a plurality of axial grooves, wherein the axial grooves extend axially from the centrifugal lubricant catcher across the first piloting surface and a web bore surface to a second piloting surface; and lubricating the second piloting surface from the axial grooves by centrifugal force.

These and other features, aspects and advantages of the present invention will become better understood with reference to the following drawings, description and claims.

### BRIEF DESCRIPTION OF THE DRAWINGS

FIG. 1 shows a cross-sectional view of a bearing sump of a turbine engine, according to the invention;

FIG. 2A shows a perspective view of a ball bearing assembly, according to the invention;

FIG. 2B shows a perspective view of a cylindrical roller bearing assembly, according to the invention;

FIG. 3 shows a rolling element bearing cage with rolling elements, according to one embodiment of the invention;

FIG. 4 shows a radial outwardly facing view of the inner circumference of the rolling element bearing cage of FIG. 3, according to the invention;

FIG. 5 shows a radial outwardly facing view of the inner circumference of a rolling element bearing cage according to a second embodiment of the invention;

FIG. 6 shows a radial outwardly facing view of an inner circumference of a rolling element bearing cage, according to a third embodiment of the invention; and

FIG. 7 is a flow chart showing a method of lubricating the piloting surfaces of a bearing cage, according to the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides a bearing cage for a bearing assembly which may have improved lubrication of piloting surfaces of the bearing cage, thereby decreasing wear and increasing the lifespan of the bearing assembly. The bearing cage may comprise a centrifugal lubricant catcher on the inner surface of one end of the bearing cage and a plurality of axial grooves in a plurality of bore web surfaces of the bearing cage to distribute lubricant more uniformly to the piloting surfaces. The bearing cage of the present invention may be useful in high speed rolling element bearings utilized in high-speed turbo machinery such as, but not limited to, high-speed gas turbine engines, machine tool spindles, turbo-pumps, and gas compressors.

Conventional high speed rolling element bearings often have a short lifespan due to wear between the bearing cage piloting surfaces and the bearing inner rings lands. This wear is due to the difficulty in maintaining and replenishing the hydrodynamic lubrication film on these surfaces. The wear may be severe enough to result in bearing failure within a matter of minutes. One way to resolve this wear problem is to introduce the lubricant between the shaft and the inner ring of the bearing, and use feed holes to centrifugally distribute the lubricant to the piloting surfaces. Such lubrication is called ‘under-race’ lubrication. However, in many designs, ‘under-race’ lubrication features cannot be incorporated. The present invention addresses the problems associated with wear between the bearing cage piloting surfaces and the bearing inner ring lands found in a conventional high speed rolling element bearings by providing improved lubrication of the bearing cage piloting surfaces that does not require under-race lubrication, thereby reducing wear and bearing failure.

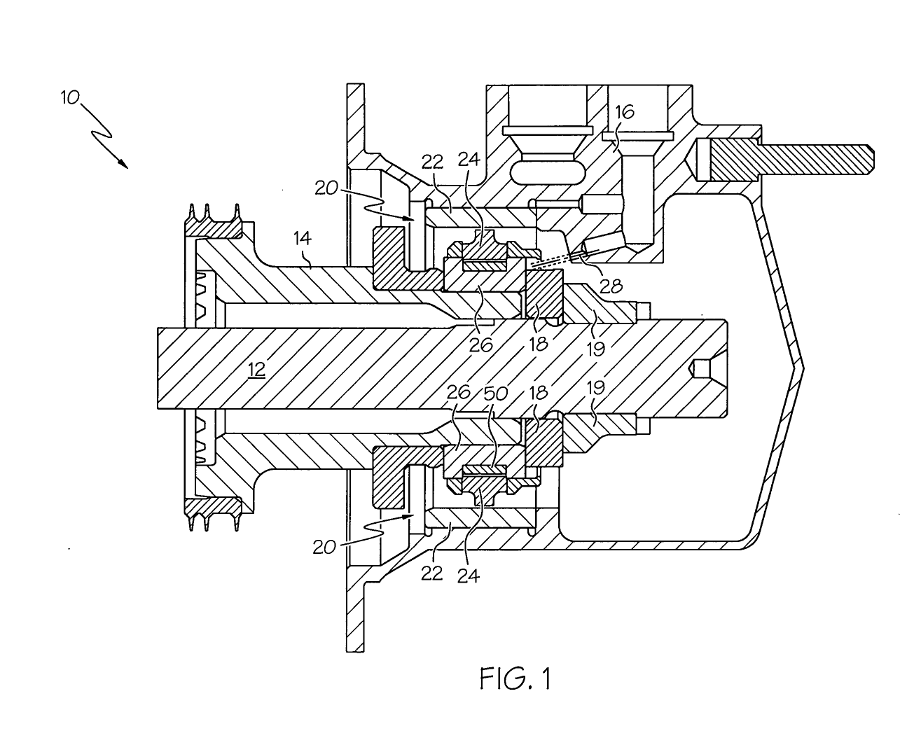

Illustrated in FIG. 1 is a bearing sump 10 of a turbine engine that may include a tie shaft 12, a coupling shaft 14, a rolling element bearing assembly 20, a bearing support housing 16, and a spacer 18. Rolling element bearing assembly 20 may further comprise inner ring 22, outer ring 26, bearing cage 24 and rolling elements 50. Spacer 18, held in place by a nut 19, axially retains inner ring 22 with an applied clamp load. Outer ring 26 may be secured to a fixed structure such as, but not limited to, bearing housing 16. Inner ring 22 may be fixedly connected with main shaft 12 through coupling shaft 14.

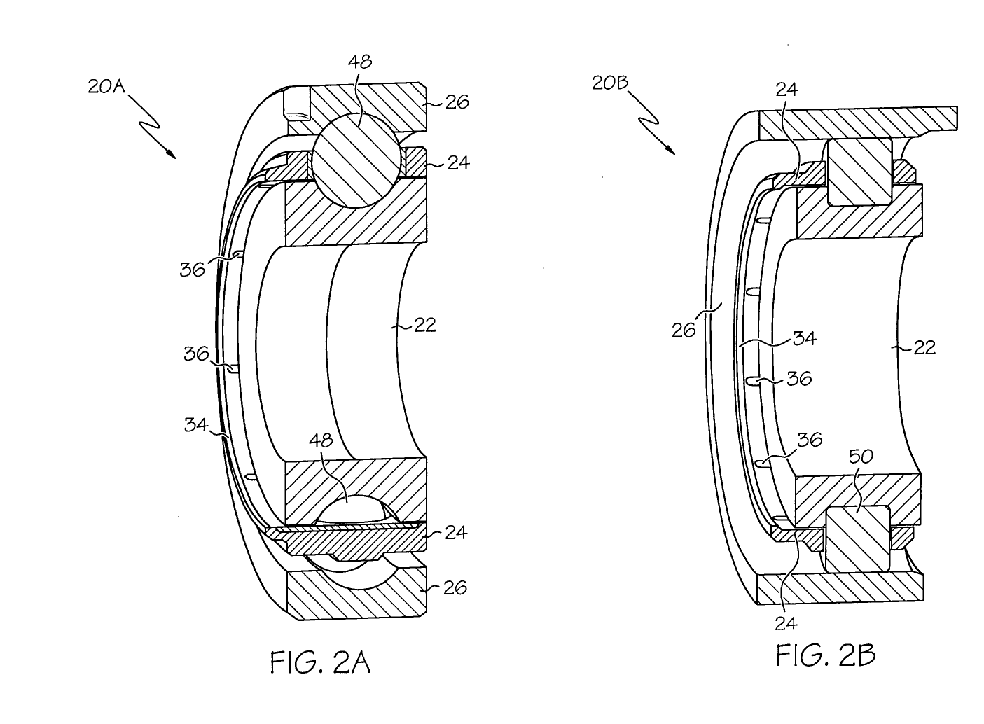

Bearing assembly 20 is illustrated in more detail in FIGS. 2A and 2B. FIG. 2A shows a ball bearing assembly 20A as one embodiment of the invention, while FIG. 2B shows an alternate embodiment, a roller bearing assembly 20B. As the only difference between ball bearing assembly 20A and roller bearing assembly 20B is the rolling element employed (i.e. ball vs. roller), herein both bearing assemblies 20A and 20B will be represented by bearing assembly 20. Bearing assembly 20 may comprise an outer ring 26, an inner ring 22, a bearing cage 24 and either bearing balls 48 (FIG. 2A) or bearing rollers 50 (FIG. 2B). Bearing cage 24 may be concentrically disposed between outer ring 26 and inner ring 22.

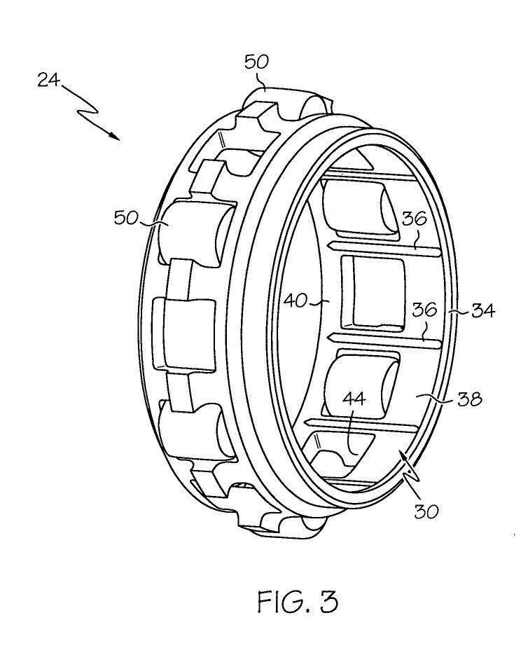

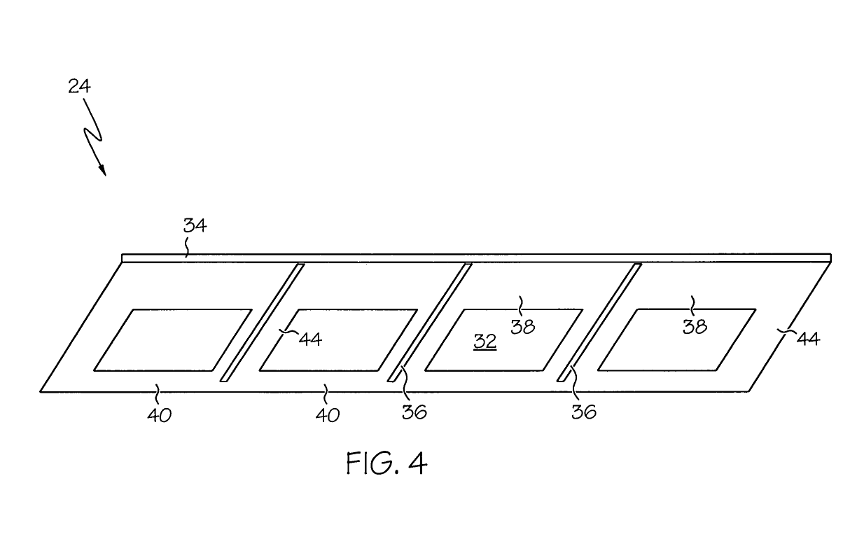

As illustrated in FIG. 3, bearing cage 24 may be a circular ring comprising a plurality of cage pockets 32 located at predetermined intervals around the ring. The size and shape of the cage pockets may be determined based on the size and shape of the rolling element. By way of non-limiting example, cage pockets 32 in FIG. 3 are designed for bearing rollers 50. Bearing cage 24 may further comprise an inner surface 30 where inner surface 30 may comprise a first piloting surface 38 and a second piloting surface 40. The first and second piloting surfaces 38, 40 provide a contact surface between inner ring 22 and bearing cage 24 to help in aligning bearing cage 24 within bearing assembly 20. First piloting surface 38 may be referred to as the lubricated piloting surface meaning that it is on the side that lubricant enters bearing assembly 20 from a lubricant jet 28 (see FIG. 1). Second piloting surface 40 may be referred to as the non-lubricated piloting surface as it is furthest away from the lubricant entry from lubricant jet 28. Inner surface 30 of bearing cage 24 may further comprise a plurality of bore web surfaces 44 as shown in FIG. 4. The plurality of bore web surfaces 44 separate the plurality of bearing cage pockets 32 and also connect first piloting surface 38 to second piloting surface 40.

Bearing cage 24 may further comprise a centrifugal lubricant catcher 34 and a plurality of axial grooves 36 as illustrated in FIGS. 3 and 4. Centrifugal lubricant catcher 34 may be a lip running circumferentially around the edge of inner surface 30 of bearing cage 24 adjacent to first piloting surface 38. Centrifugal lubricant catcher 34 may centrifugally capture lubricant during operation of bearing assembly 20 and may be positioned on the side of bearing assembly 20 which receives lubricant from lubricant jet 28. Axial grooves 36 may extend axially from adjacent the inner edge of centrifugal lubricant catcher 34 across first piloting surface 38 and bore web surface 44 to second piloting surface 40. In an illustrative embodiment, axial grooves 36 may be in the center of web bore surfaces 44. Axial grooves may extend axially from adjacent to centrifugal lubricant catcher 34 such that lubricant caught by centrifugal lubricant catcher 34 may be captured by axial grooves 36. It will be appreciated that axial grooves 36 may abut and extend from the inner edge of centrifugal lubricant catcher 34 or, alternatively, axial grooves 36 may extend axially from first piloting surface 38, close enough to centrifugal lubricant catcher 34 so that lubricant is captured by axial grooves 36 from centrifugal lubricant catcher 34. In one embodiment, axial grooves 36 may not extend to the far edge of second piloting surface 40. It will be appreciated that extending axial grooves 36 across the entire inner surface 30 of bearing cage 24, will result in loss of lubricant from bearing assembly 20. Axial grooves may extend partially across second piloting surface 40. The length of axial grooves 36 may be such that second piloting surface 40 is sufficiently lubricated during operation of bearing assembly 20. Axial grooves 36 may capture the lubricant from centrifugal lubricant catcher 34 and due to centrifugal force, feed the lubricant to both first piloting surface 38 and second piloting surface 40. In one illustrative embodiment, axial grooves 36 may extend across from about 10% to about 90% of second piloting surface 40. In a further illustrative embodiment, axial grooves 36 may extend across from about 50% to about 75% of second piloting surface 40.

The dimensions of centrifugal lubricant catcher 34 and/or axial grooves 36 may be determined using computational fluid dynamics (CFD) to provide the amount of lubrication desired for first piloting surface 38 and/or second piloting surface 40. Non-limiting examples of commercial CFD programs that may be used are FLUENT and FEMEHL. The dimensions of centrifugal lubricant catcher 34 and/or axial grooves 36 may also be dependent on the dimensions of bearing cage 24. In one illustrative embodiment, centrifugal lubricant catcher 34 has a radial height of from about 0.003 inches to about 0.100 inches and a width of from about 0.010 inches to about 0.100 inches. In another illustrative embodiment, axial grooves 36 may have a depth of from about 0.010 inches to about 0.040 inches and a width of from about 0.005 inches to about 0.050 inches. It will be appreciated that it may be desirable to have axial grooves 36 that are fairly shallow and narrow in width so that the integrity of bearing cage 24 is not compromised. The number of axial grooves 36 necessary for the desired amount of lubrication may also be calculated using CFD. In one illustrative embodiment, there is an axial groove 36 on each web bore surface 44 of bearing cage 24. In an alternative illustrative embodiment, there is an axial groove on alternating web bore surfaces 44.

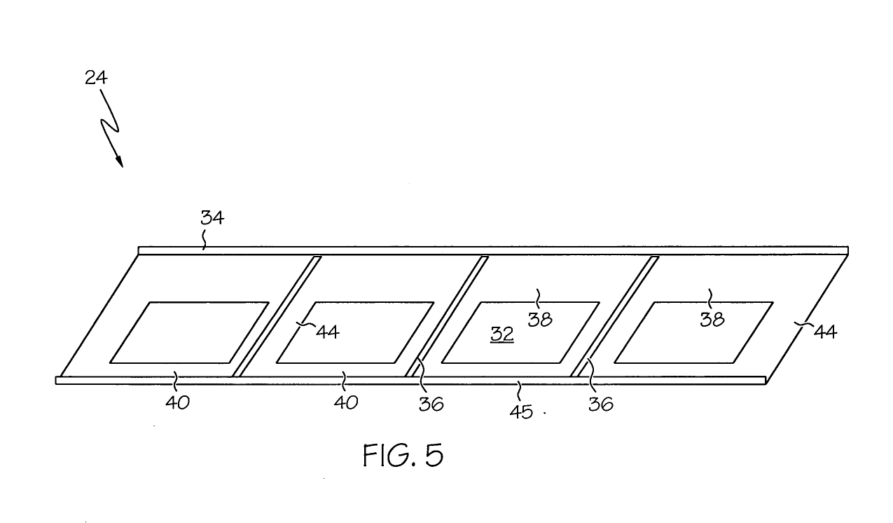

In an alternative embodiment shown in FIG. 5, bearing cage 24 may further comprise a second centrifugal lubricant catcher 45 on the opposite edge of inner surface 30 adjacent to second piloting surface 40. With second centrifugal lubricant catcher 45, axial grooves 36 may extend axially from adjacent the inner edge of first centrifugal lubricant catcher 36, across first piloting surface 38, web bore surface 44 and second piloting surface 40 to adjacent the inner edge of second centrifugal lubricant catcher 45. It will be appreciated that the presence of second centrifugal lubricant catcher 45 may prevent the loss of lubricant when axial grooves 36 extend axially across the entire inner surface 30.

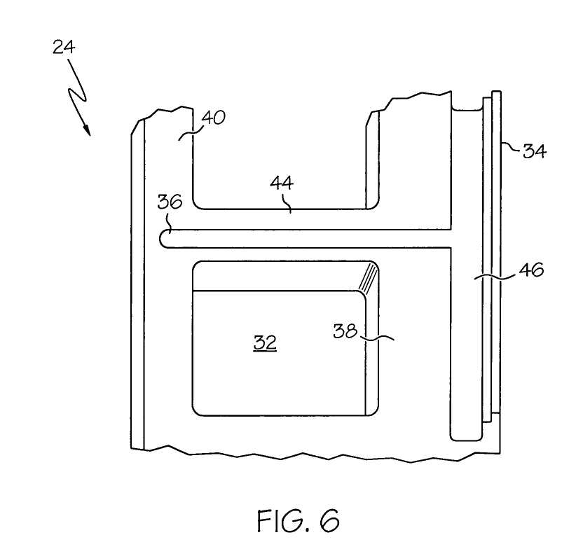

As illustrative in FIG. 6, bearing cage 24 may further comprise a circumferential groove 46 in another alternative embodiment. Circumferential groove 46 may run circumferentially around inner surface 30 adjacent to centrifugal lubricant catcher 34. Axial grooves 36 extend axially from circumferential groove 46 across first piloting surface 38, bore web surface 44 and partially across second piloting surface 40. In one illustrative embodiment, axial grooves 36 may extend across from about 10% to about 90% of second piloting surface 40. In a further illustrative embodiment, axial grooves 36 may extend across from about 50% to about 75% of second piloting surface 40. Circumferential groove 46, in combination with centrifugal lubricant catcher 34, may provide improved circumferential distribution of the lubricant than the centrifugal lubricant catcher 34 alone. The dimensions of circumferential groove 46 may be determined using computational fluid dynamics (CFD) to provide the amount of lubrication desired for first piloting surface 38 and/or second piloting surface 40. In one illustrative embodiment, circumferential groove 46 has a depth of from about 0.01 inches to about 0.05 inches and a width of from about 0.04 inches to about 0.10 inches.

In another embodiment of the present invention, bearing cage 24 may comprise centrifugal groove 46 and both first and second centrifugal lubricant catchers 34, 45 wherein axial grooves 36 may extend axially from circumferential groove 46 across first piloting surface 38, bore web surface 44 and second piloting surface 40 to the edge of second centrifugal lubrication catcher 45. In a further embodiment, bearing catcher 24 may further comprise a second circumferential groove adjacent to the second centrifugal lubricant catcher, wherein axially grooves 36 may extend axially from circumferential groove 46 to the second circumferential groove.

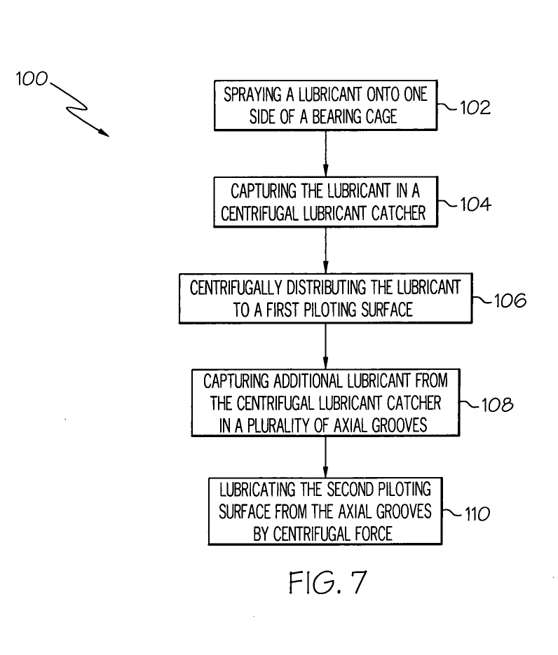

The present invention also provides a method of lubricating a first piloting surface and a second piloting surface of a bearing cage of a bearing assembly. Method 100, shown in FIG. 7, may comprise step 102 of spraying a lubricant onto one side of a bearing cage, step 104 of capturing the lubricant in a centrifugal lubricant catcher, the centrifugal lubricant catcher comprising a circumferential lip around an inner surface of the bearing cage wherein the centrifugal lubricant catcher is on the side of the bearing cage sprayed with lubricant and step 106 of centrifugally distributing the lubricant to a first piloting surface, wherein the first piloting surface is adjacent to the centrifugal lubricant catcher. The centrifugal lubricant catcher captures the lubricant, distributes it uniformly around the inner surface of the bearing cage and centrifugally directs the lubricant to the first piloting surface. Method 100 may further comprise step 108 of capturing additional lubricant from the centrifugal lubricant catcher in a plurality of axial grooves, wherein the axial grooves extend axially from the lip of the centrifugal lubricant catcher across the first piloting surface and a web bore surface to a second piloting surface and step 110 of lubricating the second piloting surface from the axial grooves by centrifugal force. The axial grooves may capture the lubricant from the centrifugal lubricant catcher and, via centrifugal force, feed the lubricant to both the first piloting surface and the second piloting surface.

It should be understood, of course, that the foregoing relates to exemplary embodiments of the invention and that modifications may be made without departing from the spirit and scope of the invention as set forth in the following claims.

We claim

1. A bearing cage for a rolling element bearing, the bearing cage comprising:
an inner surface;
a plurality of cage pockets at predetermined intervals along the circumference of the bearing cage;
a plurality of web bore surfaces on the inner surface, the plurality of web bore surfaces separating the plurality of cage pockets;
a first centrifugal lubricant catcher running circumferentially around an edge of the inner surface of the bearing cage; and
a plurality of axial grooves, the plurality of axial grooves extending axially along the plurality of web bore surfaces.

2. The bearing cage of claim 1 wherein the axial grooves extend axially from adjacent an inner edge of the first centrifugal lubricant catcher.

3. The bearing cage of claim 1 wherein the axial grooves have a depth of from about 0.010 inches to about 0.040 inches.

4. The bearing cage of claim 1 wherein the axial grooves have a width of from about 0.005 inches to about 0.050 inches.

5. The bearing cage of claim 1 wherein the first centrifugal lubricant catcher comprises a lip running circumferentially around an edge of the inner surface of the bearing cage.

6. The bearing cage of claim 5 wherein the lip has a radial height of from about 0.003 inches to about 0.100 inches and a width of from about 0.01 inches to about 0.10 inches.

7. The bearing cage of claim 1 further comprising a first piloting surface and a second piloting surface, the first and second piloting surfaces being on the inner surface of the bearing cage, wherein the first and second piloting surfaces are connected by the plurality of web bore surfaces and wherein the first piloting surface is adjacent to the first centrifugal lubricant catcher.

8. The bearing cage of claim 7 wherein the axial grooves extend axially from adjacent the first centrifugal lubricant catcher along the first piloting surface and the plurality of web bore surfaces to the second piloting surface.

9. The bearing cage of claim 8 wherein the axial grooves extend over from about 10% to about 90% of the second piloting surface.

10. The bearing cage of claim 1 further comprising a second centrifugal lubricant catcher, the second centrifugal lubricant catcher running circumferentially around the opposite edge of the inner surface of the bearing cage from the first centrifugal lubricant catcher.

11. The bearing cage of claim 10 wherein the axial grooves extend axially from the first centrifugal lubricant catcher to the second centrifugal lubricant catcher.

12. The bearing cage of claim 10 wherein the first centrifugal lubricant catcher comprises a first lip running circumferentially around an edge of the inner surface of the bearing cage and the second centrifugal lubricant catcher comprises a second lip running circumferentially around the opposite edge of the inner surface from the first lip.

13. The bearing cage of claim 1 wherein there is an axially groove extending over each web bore surface.

14. The bearing cage of claim 1 wherein there is an axially groove extending over alternating web bore surfaces.

15. The bearing cage of claim 1 wherein the axial grooves are in the center of the bore web surfaces.

16. The bearing cage of claim 1 further comprising a circumferential groove, the circumferential groove running circumferentially around the inner surface of the bearing cage and adjacent to the first centrifugal lubricant catcher.

17. The bearing cage of claim 16 wherein the axial grooves extend axially from the circumferential groove.

18. A bearing cage for a rolling element bearing, the bearing cage comprising:
an inner surface;
a plurality of cage pockets at predetermined intervals along the circumference of the bearing cage;
a plurality of web bore surfaces on the inner surface, the plurality of web bore surfaces separating the plurality of cage pockets;
a first centrifugal lubricant catcher running circumferentially around an edge of the inner surface of the bearing cage;
a circumferential groove, the circumferential groove running circumferentially around the inner surface of the inner ring and adjacent to the centrifugal lubricant catcher; and
a plurality of axial grooves, the plurality of axial grooves extending from the circumferential groove along the plurality of web bore surfaces.

19. The bearing cage of claim 18 wherein the first centrifugal lubricant catcher comprises a lip running circumferentially around an edge of the inner surface of the bearing cage.

20. The bearing cage of claim 18 wherein the circumferential groove has a width of from about 0.04 inches to about 0.10 inches and a depth of from about 0.01 inches to about 0.05 inches.

21. The bearing cage of claim 18 wherein the axial grooves have a depth of from about 0.010 inches to about 0.040 inches and a width of from about 0.005 inches to about 0.050 inches.

22. The bearing cage of claim 18 further comprising a first piloting surface and a second piloting surface, the first and second piloting surfaces being on the inner surface of the bearing cage, wherein the first and second piloting surfaces are connected by the plurality of web bore surfaces and wherein the first piloting surface is adjacent to the first centrifugal lubricant catcher and wherein the axial grooves extend axially from the circumferential groove along the first piloting surface and the plurality of web bore surfaces to the second piloting surface.

23. The bearing cage of claim 22 wherein the axial grooves extend over from about 50% to about 75% of the second piloting surface.

24. The bearing cage of claim 18 further comprising a second centrifugal lubricant catcher, the second centrifugal lubricant catcher running circumferentially around the opposite edge of the inner surface of the bearing cage from the first centrifugal lubricant catcher.

25. The bearing cage of claim 24 wherein the first centrifugal lubricant catcher comprises a first lip running circumferentially around an edge of the inner surface of the bearing cage and the second centrifugal lubricant catcher comprises a second lip running circumferentially around the opposite edge of the inner surface from the first lip.

26. The bearing cage of claim 24 wherein the axial grooves extend axially from the circumferential groove to the second centrifugal lubricant catcher.

27. The bearing cage of claim 24 further comprising a second circumferential groove, the circumferential groove running circumferentially around the inner surface of the bearing cage and adjacent to the second centrifugal lubricant catcher.

28. The bearing cage of claim 27 wherein the axial grooves extend from the first circumferential groove to the second circumferential groove.

29. The bearing cage of claim 18 wherein there is an axially groove extending over each web bore surface.

30. A bearing cage for a rolling element bearing, the bearing cage comprising:
an inner surface;
a plurality of cage pockets at predetermined intervals along the circumference of the bearing cage;
a plurality of web bore surfaces, the plurality of web bore surfaces separating the plurality of cage pockets;
a first piloting surface and a second piloting surface, the first and second piloting surfaces being on the inner surface of the bearing cage and connected by the plurality of web bore surfaces;
a centrifugal lubricant catcher, wherein the centrifugal lubricant catcher comprises a lip running circumferentially around an edge of the inner surface of the bearing cage adjacent to the first piloting surface; and
a plurality of axial grooves extending axially from adjacent to the centrifugal lubricant catcher along the first piloting surface and the plurality of web bore surfaces to the second piloting surface, wherein the axial grooves extend over from about 50% to about 75% of the second piloting surface.

31. The bearing cage of claim 30 further comprising a circumferential groove, the circumferential groove running circumferentially around the inner surface of the bearing cage and adjacent to the centrifugal lubricant catcher lip and wherein the axial grooves extend axially from the circumferential groove.

32. The bearing cage of claim 30, wherein the bearing cage is part of a bearing assembly, the bearing assembly further comprising an outer ring and an inner ring, wherein the bearing cage is concentrically disposed between the outer ring and the inner ring.

33. A rolling element bearing assembly comprising:
an inner ring;
an outer ring;
a bearing cage concentrically disposed between the inner ring and the outer ring, the bearing cage comprising an inner surface, a plurality of cage pockets at predetermined intervals along a circumference of the bearing cage, a plurality of web bore surfaces, the web bore surfaces separating the plurality of cage pockets, a centrifugal lubricant catcher, wherein the centrifugal lubricant catcher comprises a lip running circumferentially around an edge of the inner surface of the bearing cage, and a plurality of axial grooves extending from adjacent the lip of the centrifugal lubricant catcher along the plurality of web bore surfaces; and
a plurality of rolling elements, the rolling elements being disposed within the plurality of cage pockets.

34. The bearing assembly of claim 33 wherein the bearing assembly is a ball bearing assembly.

35. The bearing assembly of claim 33 wherein the bearing assembly is a roller bearing assembly.

36. The bearing assembly of claim 33 wherein the bearing cage further comprises a first piloting surface and a second piloting surface, the first and second piloting surfaces being on the inner surface of the bearing cage and connected by the plurality of web bore surfaces, wherein the first piloting surface is adjacent to the centrifugal lubricant catcher and wherein the axial grooves extend axially from adjacent the circumferential groove along the first piloting surface and the plurality of web bore surfaces to the second piloting surface extending over from about 50% to about 75% of the second piloting surface.

37. The bearing assembly of claim 36 wherein the bearing cage further comprises a circumferential groove, the circumferential groove running circumferentially around the inner surface of the bearing cage and adjacent to the centrifugal lubricant catcher and wherein the axial grooves extend axially from the circumferential groove.

38. A bearing sump of a turbine engine comprising:
a shaft;
a coupling shaft connected to the shaft;
a bearing assembly comprising an inner ring, the inner ring connected to the coupling shaft, an outer ring, and a bearing cage concentrically disposed between the inner ring and the outer ring, the bearing cage comprising an inner surface, a plurality of cage pockets at predetermined intervals along a circumference of the bearing cage, a plurality of web bore surfaces, the plurality of web bore surfaces separating the plurality of cage pockets, a centrifugal lubricant catcher, wherein the centrifugal lubricant catcher comprises a lip running circumferentially around an edge of the inner surface of the bearing cage, and a plurality of axial grooves extending from the lip of the centrifugal lubricant catcher along the plurality of web bore surfaces;
a bearing support housing, the bearing support housing connected to the outer ring of the bearing assembly; and
a lubricant jet, the lubricant jet being positioned in the bearing support housing such that lubricant is delivered by the jet directly to the bearing assembly in such a way that the majority of lubricant is captured by the centrifugal lubricant catcher.

39. The bearing sump of claim 38 wherein the bearing cage further comprises:
a first piloting surface and a second piloting surface, the first and second piloting surfaces being on the inner surface of the bearing cage and connected by the plurality of web bore surfaces, wherein the first piloting surface is adjacent to the centrifugal lubricant catcher;
a circumferential groove, the circumferential groove running circumferentially around the first piloting surface and adjacent to the centrifugal lubricant catcher lip; and
wherein the axial grooves extend axially from the circumferential groove along the first piloting surface and the plurality of web bore surfaces to the second piloting surface, extending over from about 50% to about 75% of the second piloting surface.

40. A method of lubricating a first piloting surface and a second piloting surface of a bearing cage of a bearing assembly comprising the steps of:
spraying a lubricant towards one side of the bearing cage;
capturing the lubricant in a centrifugal lubricant catcher wherein the centrifugal lubricant catcher is on the side of the bearing cage sprayed with lubricant;
centrifugally distributing the lubricant to a first piloting surface, wherein the first piloting surface is adjacent to the centrifugal lubricant catcher;
capturing additional lubricant from the centrifugal lubricant catcher in a plurality of axial grooves, wherein the axial grooves extend axially from the centrifugal lubricant catcher across the first piloting surface and a web bore surface to a second piloting surface;
lubricating the second piloting surface from the axial grooves by centrifugal force.

41. The method of claim 40 wherein the centrifugal lubricant catcher comprises a lip running circumferentially around an inner surface of the bearing cage.

42. The method of claim 40 wherein the lubricant is sprayed under pressure from a jet.

43. The method of claim 40 wherein the bearing assembly is a high speed rolling element bearing.

44. The method of claim 40 wherein the lubricant is an oil.
